(19) United States
(12) Patent Application Publication
(10) Pub. No.: US 2002/0120910 A1
(43) Pub. Date: Aug. 29, 2002

(54) Method for optimization of temporal performances with rapid convergence

(76) Inventors: Olivier Giaume, Biot (FR); Beatrice Brochier, Mougins (FR); Philippe Alves, Cannes (FR); Christelle Faucon, Plascassier (FR)

Correspondence Address: U.S. Philips Corporation, 580 White Plains Road, Tarrytown, NY, 10591, US

(21) Appl. No.: 10/028,099

(22) Filed: Dec. 21, 2001

(30) Foreign Application Priority Data
Dec. 28, 2000 (FR) 0017210

(51) Int. Cl. G06F 17/50

(52) U.S. Cl. 716/6; 716/2; 716/5

(57) ABSTRACT

The present invention relates to a method for optimization of temporal performances of a network of electronic cells, comprising a plurality of cells which are taken from a library (LIB), comprising several categories of cells, the cells of a same category all having the same functionality, and being arranged in increasing order of power. The method according to the invention comprises the following steps:

accurate computation of propagation times (dt) of signals which pass through each cell of the network; and

identification of cells which have a value of the propagation time computed (dti) greater than a predetermined reference value (Ref).

### FIELD OF THE INVENTION

The present invention relates to a method for optimization of temporal performances of a network of electronic cells, comprising a plurality of cells which are taken from a library, comprising several categories of cells, the cells of a same category all having the same functionality.

### BACKGROUND OF THE INVENTION

Methods of this type are commonly used in the microelectronics industry, in order to improve integrated circuits. In order to make an integrated circuit capable of processing quickly large volumes of data, it is in fact necessary to minimize as far as possible the propagation times of signals which pass through said circuit.

Most known methods for optimization require identification of at least one critical path, which conventionally consists of the longest passage which exists between two memory cells. The time which is necessary for a signal to travel along this passage determines a maximum frequency for the clock signals which are designed to pace the memory cells which delimit the critical path, and thus defines the frequency of functioning of the integrated circuit, and consequently a throughput of data which said circuit is capable of processing. A reduction in the passage time corresponding to the critical path thus permits an increase in the maximum value of this throughput. A method of this type for optimization, which identifies critical paths, is described in particular in U.S. Pat. No. 5,872,717. The implementation of a method for optimization of this type has a certain number of disadvantages.

Firstly, a critical path can be identified only at the expense of temporal analysis of all of the interconnections between the cells which constitute the network, which requires a considerable calculation time, owing to the volume of information to be taken into account. In addition, for a constant number of cells included in the network, the value of this calculation time will be greater as the complexity of the interconnections is greater. It is thus difficult to predict the duration necessary for identification of the critical paths, required by the known methods for optimization.

The known method additionally comprises alteration of the size of certain cells which intervene along the critical path identified, in order to reduce the corresponding passage time. However, the said cells can intervene in other data paths which will not have been taken into consideration, and the fact of modifying these cells can increase the duration of these other passages, and give rise to new critical paths. After each alteration of the size, it is therefore necessary to carry out a new identification of critical paths of the modified network of cells, and if necessary to replace other cells which intervene in the new critical paths thus identified.

It will be appreciated that a large number of iterations may be necessary before converging towards a network which will contain only critical paths with passage times which are acceptable in the light of a specification which governs the temporal performances of the integrated circuit. It is also possible that a convergence of this type may never be achieved.

It is apparent from the foregoing information that the known methods for optimization, which are based on identification of critical paths, have a significant and non-predictable cost of implementation, and may prove to be inefficient.

The object of the invention is to eliminate these disadvantages, by proposing a method for optimization of temporal performances, which does not require specific identification or modification of critical paths of the network of cells.

In fact, according to the invention, a method for optimization according to the introductory paragraph comprises the following steps:

accurate computation of the propagation time of signals which pass through each cell of the network; and

identification of cells which have a value of the propagation time computed greater than a predetermined reference value.

The method according to the invention analyses in one process the behavior of each cell included in the network, independent of its connections with the other cells in the network. The duration of this analysis is thus independent of the complexity of the interconnections between the cells of the network, and depends only on the total number of cells.

In addition, all the cells in the network which have an excessively long propagation time can simultaneously be replaced by cells which are more powerful, and therefore more rapid. This eliminates the risks associated with local modifications, which tend to disrupt other portions of the network, and limits considerably the iterations necessary in order to obtain critical paths with an acceptable duration. In practice, if the reference value is well selected, a single iteration will be necessary, and immediate convergence can then be obtained.

According to an embodiment of the invention, a predetermined threshold value valⱼ is allocated to each cell of rank j of a same category, and when a cell of rank i identified must be replaced by a cell of a higher rank k, the value of k is at least equal to i+j, if the value of the propagation time computed for the said cell of rank i is greater than the predetermined threshold value valⱼ of the cell of rank j.

This embodiment of the invention makes it possible to assure that a replacement cell, which is designed to replace a cell identified as being insufficiently powerful, since the value of its computed propagation time is greater than the reference value, will have sufficient power for the propagation time of the said replacement cell to be lower than the reference value, which contributes towards increasing the above-described speed of convergence.

According to a particular embodiment of the invention, when a cell of rank i identified must be replaced by a cell of a higher rank k, the value of k is equal to i+j, if the value of the propagation time computed for the said cell of rank i is within the predetermined threshold values valⱼ and valⱼ₊₁ of the cells of consecutive ranks j and j+1.

This embodiment makes it possible to assure that the power of the replacement cell is just great enough for its computed propagation time to be lower than the reference value.

In practice, replacement of a cell which is too slow, by a more rapid cell, mostly leads to an increase in the size of the said cell, which is inherently a detrimental consequence, since it gives rise to an increase in the dimension of the network of cells, and thus of the manufacturing cost of the latter. The particular embodiment previously described makes it possible to reduce the extent of the detrimental effects which arise from the replacement operation, by limiting the increase in the size of the cell to an increase that is strictly necessary to enable the cell to have an acceptable propagation time.

According to a variant of the invention, the execution of the replacement step is subject to validation by the user of the method for optimization.

This variant allows the user to select the cells he wishes to replace, and thus to control the increase in the dimension of the network, resulting from implementation of the method for optimization.

In its most direct application, the invention also relates to an integrated circuit, which comprises a network of cells, the temporal performances of which have been optimized by means of a method such as that previously described.

Finally, in one of its applications, the invention also relates to a receiver device for radio signals, which comprises an integrated circuit of this type.

These and other aspects of the invention are apparent from and will be elucidated, by way of non-limiting example, with reference to the embodiment(s) described hereinafter.

### In the drawings:

FIG. 1 shows a flow chart which describes a method for optimization according to an embodiment of the invention;

FIG. 2 shows a diagram which makes it possible to visualize the effects of a method of this type on the structure of a network of cells;

FIG. 3 shows a diagram which illustrates a possible application of an integrated circuit which includes a network of cells of this type; and

FIG. 4 shows an example of replacement of cells according to the method of optimization of FIG. 1.

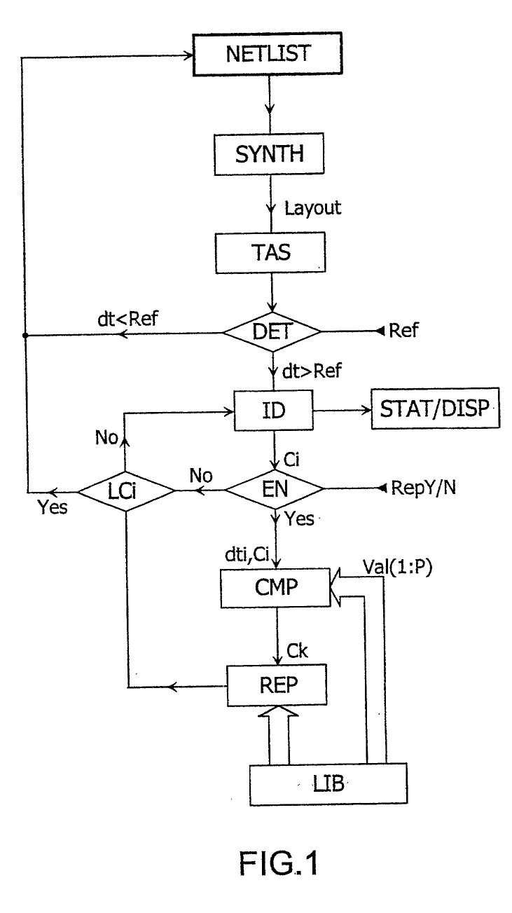

FIG. 1 shows schematically a methodological chain, which makes it possible to generate masks which are representative of the topography of an integrated circuit, in which chain a method according to the invention is implemented.

In a first step, a user of the chain, who will usually be an integrated circuit designer, produces a list of interconnections NETLIST, which includes definitions of each of the cells which constitute the network, as well as a description of the input and output connections specific to each cell. In most applications, the cells will be logic gates, the models of which are listed in a library of cells LIB. This library contains several categories of cells, the cells of a same category all having the same functionality, and being preferentially arranged in increasing order of power.

During a synthesis step SYNTH, the user executes a synthesis program, which, on the basis of the list of interconnections, generates a drawing, Layout, of the topography of the network of cells.

During a temporal analysis step TAS, a computation program computes accurately propagation times dt of signals, which pass through each cell of the network. To this end, said program is based on source file currently called SPEF “Standard Parasitic Extraction Format” comprising physical parameters such as capacitances or resistances. Said physical parameters come from a mask representing physically the circuit, said mask being conceived during a known step of place and route called “Back-End”. The computation program extracts a final file at the standard format SDF “Standard Delay Format”, said file comprising the propagation times computed. It can be noted that by computing accurately the propagation time dt for each cell, we avoid having an important margin of error on said time at the end of the cells treatment and in particular during the replacement of some cells. Thus, it avoids to make a big number of iterations and consequently, it avoids to diverge from the network we want to obtain.

Programs of this type, for synthesis and computation, are common logic tools, which are available on the market for software to assist the design of integrated circuits.

During a detection step DET, each computed propagation time value dt is compared with a reference value Ref, which is predetermined by the user. If no computed propagation time value dt is greater than the reference value Ref, this means that the temporal performances of the network of cells defined by the list of interconnections NETLIST are acceptable for the user, according to a specification with which the integrated circuit which he is designing must comply. The list of interconnections NETLIST is then validated, without needing to be modified. If, on the other hand, certain computed propagation time values dt are greater than the reference value Ref, this means that, in principle, the corresponding cells must be replaced by more powerful cells with the same functionality, which have shorter propagation times.

These cells are identified during an identification step ID, and, in the particular embodiment of the invention now described, a display step STAT/DISP informs the user of the existence of these cells, which are liable to be replaced. In practice, the display itself can take various forms, such as a list of the cells which are liable to be replaced, their physical location in the topography Layout, and/or statistical data, such as the ratio between the number of cells which are liable to be replaced, and the total number of cells included in the network, or a ratio of the corresponding surface areas.

In this embodiment of the invention, a validation step EN subjects the execution of replacements to validation by the user, who, by means of a message RepY/N, determines whether a cell which is liable to be replaced must be replaced or not. This validation can be carried out case by case, but the user can also be left the possibility of determining simply a percentage of the number of cells effectively liable to be replaced, for example a percentage of 5%, and the cells to be replaced can then be selected randomly by the method for optimization. Thus, the choice of the percentage of the cells to be modified, and in particular if a small percentage is taken compared to the number of existing cells, enables to modify said cells very fast without error during the place and route step, such a modification of cells being called ECO “Engineering Change Order”.

In the example now described, the actual replacement of each cell which is liable to be replaced, the identity Ci of which has been stored during the identification step ID, requires validation by the user. If the user chooses not to modify any cell, or not to modify the final cell which is liable to be replaced, known as Lci, the list of interconnections NETLIST is validated in its fast state. The replacement of a cell which is liable to be replaced Ci is carried out as follows:

During a comparison step CMP, the computed propagation time dti of the cell which is liable to be replaced Ci is compared with predetermined threshold values valⱼ allocated to various cells Cj, which belong to the same category as the cell which is liable to be replaced Ci, and are present in the library LIB. Preferentially, there are four threshold values valⱼ.

These values valⱼ are temporal values, and increase according to the rank of the cells Cj. They are issued by the library LIB, which is then configurable, in the form of a word Val (1:P) in this example, which means that each category comprises P cells with the same functionality, arranged in increasing order of power, from 1 to P.

On completion of the comparison step CMP, the rank k of a cell Ck which is designed to replace the cell which is liable to be replaced Ci, with a rank i, is identified and defined as being equal to i+j, if the value of the computed propagation time dti for the cell which is liable to be replaced Ci is within the predetermined threshold values valⱼ and valⱼ₊₁ of the cells of consecutive ranks j and j+1, which can be written in the form k=i+j, if valⱼ<dti<valⱼ₊₁.

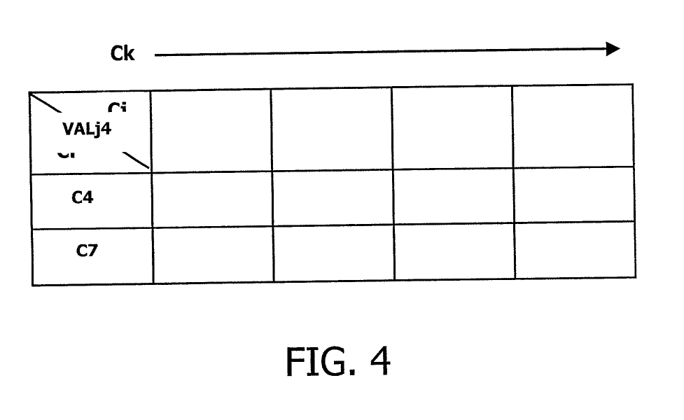

FIG. 4 shows an example of possible replacement according to a category of cells. Thus, in this example, 4 threshold values valj1, valj2, valj3 and valj4, and two categories of cells are illustrated. There is a cell of category C0, which can be replaced by one of the four possible replacement cells C1, C2, C3 and C4 of the same category according to their corresponding threshold values. Likewise, there is a cell of category C1 , which can be replaced by one of the four possible replacement cells C3, C5, C6 and C7 of the same category. For example, if a cell of category C1 which is liable to be replaced has a propagation time dt1 which is greater than valj2 and smaller than valj3, the cell of rank k=3 is C6.

During a replacement step REP, the parameters which define the model of the replacement cell Ck are taken from the library LIB, and replace those of the cell which is liable to be replaced Ci within the list of interconnections NETLIST.

If this is the final cell which is liable to be replaced LCi, the list of interconnections NETLIST is validated in this state. Otherwise, the replacement of a new cell which is liable to be replaced Ci, identified during the identification step ID, is submitted for validation to the user, during a new validation step EN.

For a cell which is liable to be replaced Ci to which no replacement cell Ck defined in the library LIB corresponds, no replacement is done. These cells, which are liable to be replaced are memorized in a file. This file can be used later on in order to find another solution to solve the problem of the cells, which are not replaced.

When the list of interconnections NETLIST has been validated, it will be sufficient to execute the synthesis step SYNTH, in order to obtain a drawing, Layout, of the topography of the optimized network of cells, in its definitive state.

It can be seen that the method for optimization according to the invention is simple to implement, and is easy for the user to control.

On completion of a single temporal analysis step TAS, all the cells which have an excessively lengthy propagation time can be replaced, which assists convergence towards a network with temporal performances which are acceptable to the user.

Moreover, thanks to the possible parameterization of the reference value Ref and of the threshold values valⱼ by the user, a great flexibility is acquired at the level of the treatment of the cells. According to the technology of the circuit that is used, the values Ref and valⱼ are parameterized differently. For example, for a technology of 0.2 microns, the reference value Ref is 0.4 ns, whereas for example, four threshold values valⱼ are 0.4 ns, 0.6 ns, 0.85 ns and 1 ns. In an empiric manner, a good reference value Ref can be equal to the technology used for an average propagation time. However, in order to take into account the propagation times which are greater, the reference value can be preferentially taken equal to two times the technology used, which is the case in the example taken of the technology of 0.2 microns, as the value is 0.4 ns.

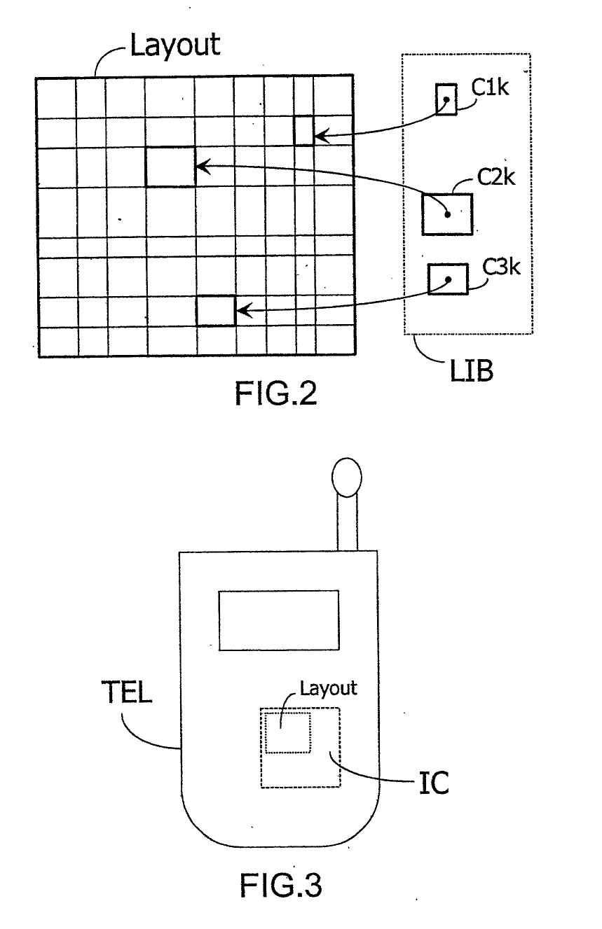

FIG. 2 makes it possible to visualize the physical consequences of implementation of the method for optimization according to the invention. This figure shows schematically the drawing, Layout, of the topography of the network of cells obtained on completion of the synthesis step. This network contains three cells which are liable to be replaced, shown in bold in this example, and are identified as such on completion of the steps of temporal analysis, detection and identification. Subject to validation by the user, these cells will be replaced respectively by cells C1k, C2k and C3k which are in the same category but are more powerful, the mask design of which will be taken from the library LIB.

Although, in order to facilitate identification of each cell which is liable to be replaced, and of its replacement C1k (for 1=1 to 3), the said cells have identical dimensions in the Figure, it will be appreciated that in practice, the surface area of the replacement cell C1k will be larger than that of the cell which is liable to be replaced.

It is understood that it is possible that the replacement of a cell, which is liable to be replaced by another cell, influences the neighbored cells, which lead to the modification of the propagation time of the cell computed previously. However, said modification is very slight and has no consequence on the circuit. There is no divergence observed and it is not necessary to apply a big number of iterations in the temporal analysis.

FIG. 3 illustrates one of the many possible applications of the invention. This figure shows highly schematically a radio signal receiver device, in this case a mobile telephone TEL, which comprises an integrated circuit IC, comprising a network of cables, the topography, Layout, of which, has been optimized by means of a method for optimization according to the invention.

1. A method for optimization of temporal performances of an network of electronic cells, comprising a plurality of cells which are taken from a library, comprising several categories of cells, the cells of a same category all having the same functionality, which method comprises the following steps:
accurate computation of propagation times of signals which pass through each cell of the network; and
identification of cells which have a value of the propagation time computed greater than a predetermined reference value.

2. A method for optimization as claimed in claim 1, wherein a predetermined threshold value valⱼ is allocated to each cell of rank j of a same category, and wherein, when a cell of rank i identified must be replaced by a cell of a higher rank k, the value of k is at least equal to i+j, if the value of the propagation time computed for said cell of rank i is greater than the predetermined threshold value valⱼ of the cell of rank j.

3. A method for optimization as claimed in claim 2, wherein, when a cell of rank i identified must be replaced by a cell of a higher rank k, the value of k is equal to i+j, if the value of the propagation time computed for said cell of rank i is within the predetermined threshold values valⱼ and valⱼ₊₁ of the cells of consecutive ranks j and j+1.

4. A method for optimization as claimed in claim 1, wherein execution of the replacement step is subject to validation by the user of the said method.

5. An integrated circuit comprising a network of cells, the temporal performances of which have been optimized by means of a method according to claim 1.

6. A receiver device for radio signals, comprising an integrated circuit according to claim 5.
